(19) United States
(12) Patent Application Publication
(10) Pub. No.: US 2003/0018564 A1
(43) Pub. Date: Jan. 23, 2003

(54) Method of operating a game of chance utilizing bidding over a network

(76) Inventors: Marc Antoine Bonnier, Calgary (CA); Karl Kowalczyk, Calgary (CA); Joshua Leung, Calgary (CA); Bich Ngoc Hoang, Calgary (CA)

Correspondence Address: GOWLING LAFLEUR HENDERSON LLP, Suite 1400, 700-2ND STREET S.W., CALGARY, T2P 4V5, CA

(21) Appl. No.: 09/908,675

(22) Filed: Jul. 20, 2001

(51) Int. Cl. G06F 17/60

(52) U.S. Cl. 705/37

(57) ABSTRACT

A method of operating a game of chance, for fun or profit. Players first bid in an “auction” to qualify for the right to bet on the outcome of a pre-defined Event. Winning an Auctioning Session does not guarantee receipt of the wager pool—the successful Player/Bidder wins a mere chance at the pooled value of the wagers of all prior bidding Players. To win the Pool the successful Bidder must also have correctly predicted the Outcome of the Specified Event. The manner in which (game Operator) “house” risk is instead distributed to Players permits a method in which the game Operator may always receive revenues regardless of the event or its outcome. Auctioning Sessions are run by a server with no need of human auctioneers and end both at random (outside the control of the Operator) and without notice to the Players as a means of creating both suspense and credibility in the integrity of the game. In a preferred embodiment the game is globally accessible through the InterNet, but may also run on private networks.

### FIELD OF THE INVENTION

The present invention relates to a method of operating a game, more particularly a method of operating a game of chance in which Players submit bids over a network.

### BACKGROUND OF THE INVENTION

The disclosed invention relates to a new application of auctioning to the gaming industry. To date there is no auction betting game in existence. Moreover, auctions are typically low profit while odds betting games are typically high risk for the Operator.

Traditional betting on horses, at sports events and the like consists of the Operator (“house”) fronting money in a single level game against which money Players effectively compete only with the house. Everyone can enter the “game” by putting up an amount based on which their winnings will be determined if they correctly predict the outcome of a subject Event. Traditionally, small Players win small amounts and big Players win bigger amounts—unlike the present method in which Players earn a chance to win a common pool of their wagers regardless of the number or amount of their bids. The prior art in the gaming industry has concentrated on teaching variations on the traditional “house centric” and pool driven models of betting in which the Operator shares risk with the Players in exchange for larger returns related to the amount bet and the “odds” of a specified outcome.

The cost-effective automation of playing certain types of game, including hockey pools, has been difficult since such games typically require a dealer and only a relatively small number of Players may play the game with a single dealer. However, with the proliferation of computerized networks and the explosion in the number of home computers linked to the Internet, it is desirable to have an automated gaming system for betting games wherein large numbers of remote Players may cost-effectively and efficiently participate in such games. Furthermore, it has been difficult to cost-effectively provide a network gaming system on such networks as the Internet in that gaming restrictions prohibit wagering and ante fees in most contexts except for situations that are based on local area networks within a casino. However, since there are many potential Players who do have an interest in playing casino-type games, it is also desirable to have a way for Operators to benefit from supplying access to such games. Accordingly, it would be desirable to have a system that utilized a gaming context as a vehicle for delivering product and/or service information to users of a network such as the Internet. In particular, it is desirable to have a data processing system that, at a reduced risk or at substantially no risk to the Operator, provides a large number of Players with the ability to place bets over the Internet, but operating in a novel manner to make such “game” desirable over the traditional placing of bets over the telephone.

Auction related prior art reviewed includes: U.S. Pat. No. 6,161,099, and U.S. Pat. No. 5,835,896. In U.S. Pat. No. 6,161,099 granted to MuniAuction, Inc. (“'099”), the electronic network auction process and apparatus relate to bonds and other financial instruments for which it is an advantage to the issuer to have interested persons from all across the planet be enabled to bid remotely. More importantly, under '099 the auctioneer informs bidders how much time remains in the auction. The present invention does not relate to financial instruments, nor does it permit Players to know when the auctioning component will end. In U.S. Pat. No. 5,835,896 granted to Onsale, Inc. (“'896”) there is no human auctioneer involved in an electronic network auction method and system for transmitting (some parts via e-mail) and processing information relating to merchandise being bid for in the traditional auction model under which bid amounts do not accumulate, but rather “fall” from the auction as higher bids for the merchandise replace them. Neither '099 nor '896 involves a 2 level concept of bidding to get into something else, nor are they otherwise obviously capable of adaptation as a game for persons skilled in games or auctions.

### BRIEF SUMMARY OF THE INVENTION

The disclosed invention solves the Operator's problems of low profit and high risk by keeping all the Players' Bid funds in the auction, which is ended at random, and transferring the entire risk of the casino style game away from the Operator or “house” to the Players. In one of its broadest embodiments, the invention comprises a method of operating a game of chance by designating a specified Event having a plurality of possible Outcomes, then conducting an Auctioning Session comprising receiving Bids from a plurality of Associated Players, wherein each Bid comprises a Value Wager and a Bet Outcome specifying a particular outcome in respect of the specified Event; and then terminating the Auctioning Session after a random interval of time.

In another of its broadest embodiments, the invention comprises a method of operating a game of chance by: designating a specified Event having a plurality of possible Outcomes; creating with respect to an Associated Player a Player Account that is provided with funds by the Associated Player; offering an Auctioning Session comprising receiving Bids from a plurality of Associated Players, wherein each Bid comprises a Value Wager and a Bet Outcome specifying a particular Outcome in respect of the Specified Event; accumulating the Value Wagers of all Bids into a Pool; terminating the Auctioning Session after a random interval of time; upon occurrence of an Outcome in respect of the specified Event, determining the last Associated Player prior to termination of the Auctioning Session, and determining if the Bid of said Player predicted that Outcome; and providing substantially all of the Pool to said Player if said Player predicted that Outcome from said plurality of possible Outcomes.

In another of its broadest embodiments, the invention comprises a method of operating a game of chance by: designating a specified Event having a plurality of possible Outcomes; offering an Auctioning Session, said Auctioning Session comprising receiving at least one Bid from an Associated Player wherein said Bid comprises a Value Wager and a Bet Outcome specifying a particular Outcome in respect of the specified Event; ending said Auctioning Session at a randomly determined point in time; identifying the last Bid in time and the Associated Player; subsequent to occurrence of said Event, identifying a Correct Outcome of said plurality of Outcomes; comparing said Correct Outcome of said Event with the Bet Outcome associated with said last Bid; and if the Bet Outcome associated with said last Bid matches said Correct Outcome, awarding to the Player who submitted said last Bid a reward based on, but not necessarily equal to, the combined value of all Bids prior in time to said last Bid.

Auctioning Sessions may be implemented and terminated, without prior notice to the Players, in a variety of ways. Auctioning off the right to bet on an event is novel as is leaving the Players in suspense respecting how long they have to “win the auction”. In one of its broad embodiments, the method lowers financial risk to the Operator by working from pre-funded Player Accounts. With the exception of promotional Auctioning Sessions in which the Operator “seeds the game” with a large opening Pool, a winning Player is paid by the losing Players and the Operator receives a profit (typically a percentage of the Pool on a straight or variable scale) from conducting each Auctioning Session. In a preferred embodiment, when the Player who holds the last Bid (i.e. wins the auction) and thereafter loses the game, the Operator retains at least a portion of the Value Wager submitted by said Player holding the last Bid, and returns the balance of the Pool to Players not associated with the last Bid. In another embodiment, the invention comprises a method of operating a game of chance that includes the Operator rewarding a winning Player with non-monetary forms of compensation such as points, tickets, certificates, merchandise, credits, or vouchers of many different types.

Unlike traditional Auction bidding, Players participating in the present invention are not directly bidding to acquire a tangible asset, since in the present invention winning the auction wins only the chance to win the “game”. Also unlike a traditional auction, Players do not automatically drop out of the auction when they are outbid, because all funds bid will remain at risk unless and until the bet made (i.e. the outcome specified) was wrong.

Unlike some forms of traditional Pool Betting, Players participating in the present invention are normally making the same bet (i.e. the same outcome has been specified) since each auctioning session specifies a particular outcome for the event in respect of which the session is offered. The unusual result is that Players who correctly specified the outcome pay their money to the one Player who both specified the correct outcome and won the auction. Even if all Players in a session bet correctly, then no funds are returned to any Players, except the highest Player, who takes the pool (less a fee to the Operator) consisting of the money of the Player's colleagues who also bet correctly. Another unusual feature, resulting in the need to “double think” the desired outcome, is that if Players have actually bet incorrectly, then all the funds in the Pool are returned to the Players, except the highest Player, who loses the said Player's last Bid to the house.

In order to overcome the disadvantages of the prior art in casino-style gaming, the present invention builds an entirely new game and takes advantage of new technologies to deliver the invented game in a fresh and exciting manner. The present invention relates to the operation of the entirely new game of “Auction Betting” in which Players must first bid in an unusual auction to qualify for the right to bet on the outcome of an event. The successful Player (bidder) wins only a chance at the pooled bids of all prior bidding Players. All the Players who fail to hold the final bid are “along for the ride” hoping to get a mere refund of their prior bid amounts, consequently Players will want to be the “last man standing” since the bid amount remaining at risk is reduced.

### BRIEF DESCRIPTION OF THE DRAWINGS

The present invention is described, by way of example only, in order to be easily understood and practised, with reference to the accompanying five drawings, in which:

FIG. 1 is a flowchart that illustrates one of the broadest embodiments of the method of the present invention of operating a game of chance;

FIG. 2 is a flowchart that illustrates an embodiment of the invented method based on claim 19.

FIG. 3 is a flowchart that illustrates an embodiment of the invented method based on claim 11.

FIG. 4 is a flowchart that illustrates an embodiment of the invented method based on claim 12.

FIG. 5 is a flowchart that illustrates an embodiment of the invented method based on claim 1.

### DETAILED DESCRIPTION OF THE PREFERRED EMBODIMENT

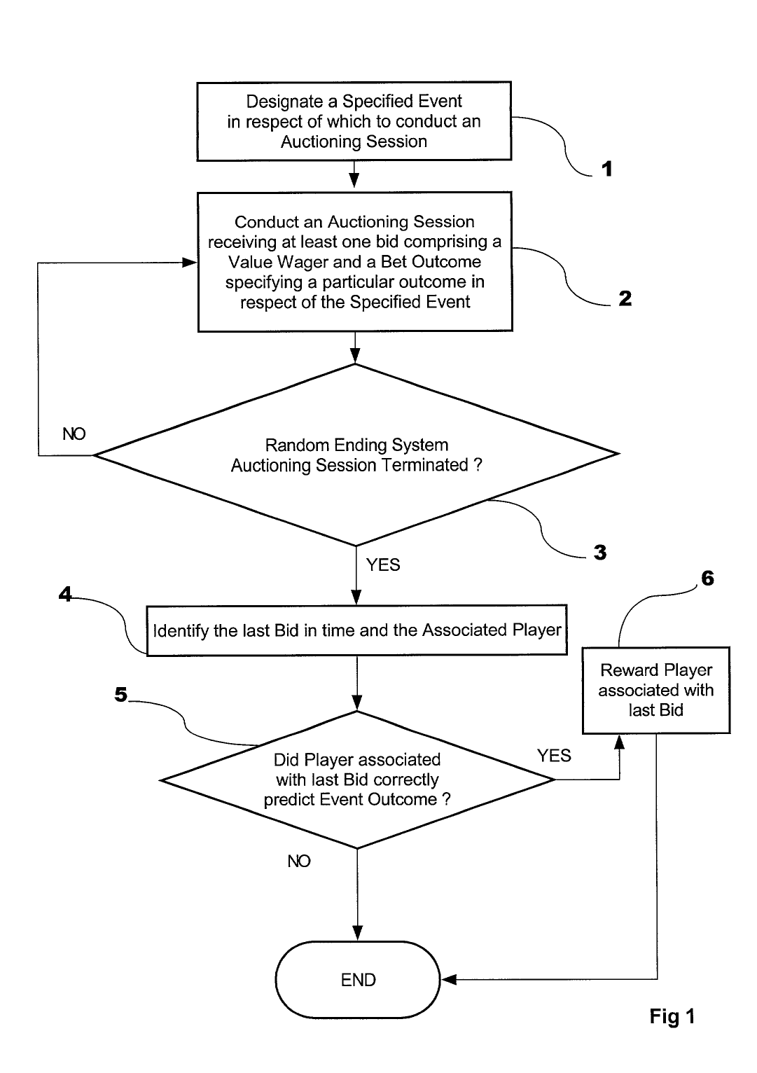

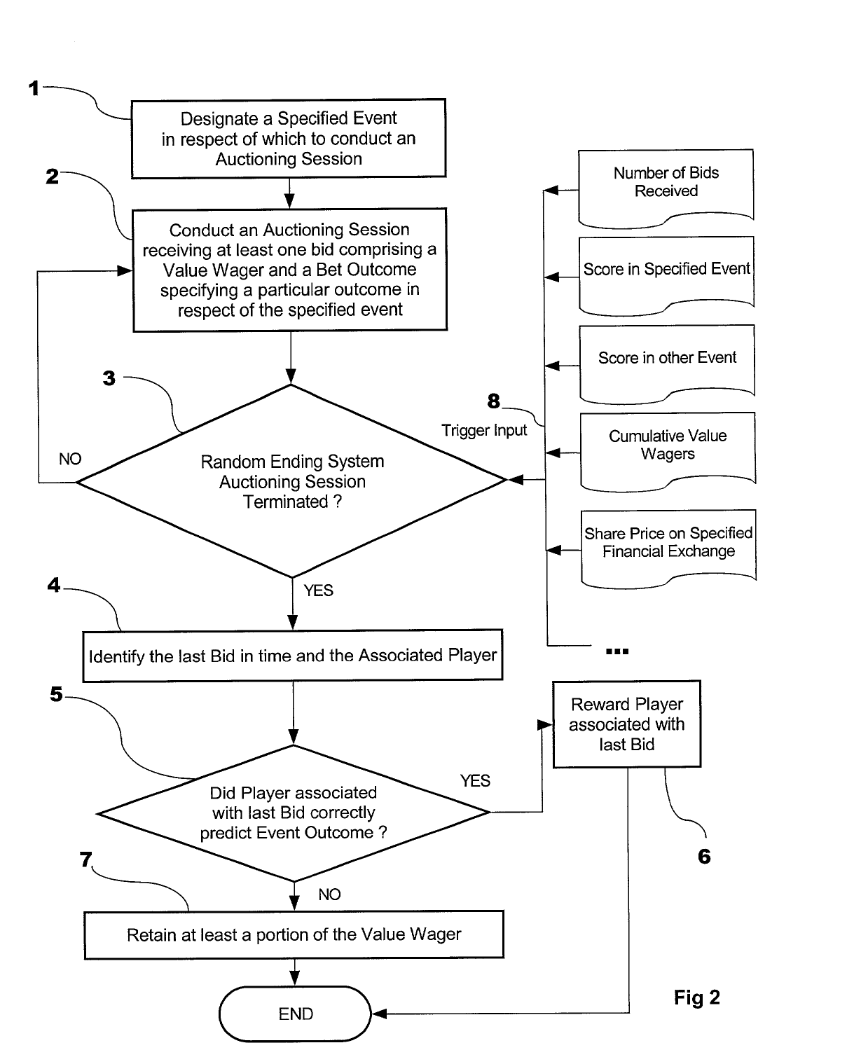

In one of the broadest embodiments of the present invention as shown in FIG. 1, the invention comprises a method of operating a game of chance by designating a Specified Event 1 having a plurality of possible Outcomes, and then conducting an Auctioning Session 2 by receiving at least one Bid from a plurality of Associated Players, who Bid by placing a Value Wager and a Bet Outcome specifying a particular outcome in respect of the Event specified. The Auctioning Session ends randomly 3, subsequent to which the last Bid in time and the Player associated with said Bid are identified 4. It is thereafter determined 5 whether the Player associated with the last Bid correctly predicted the Outcome of the Specified Event. The Player associated with the last Bid is rewarded 6 only if said Player correctly predicted the Outcome of the Specified Event. In another of the present invention's broadest embodiments, as shown in FIG. 2, the Random Ending 3 in the above described embodiment is triggered by an external input signal 8 from a source outside the control of the game Operator. And, if at 5, the Player associated with the last Bid failed to correctly predict the Outcome of the Specified Event, then the game Operator retains 7 at least a portion of the Value Wager associated with the last Bid. Alternatively, as mentioned above, if the Player correctly predicted the Outcome of the Specified Event, then such Player is awarded at least a portion of the Pool 6.

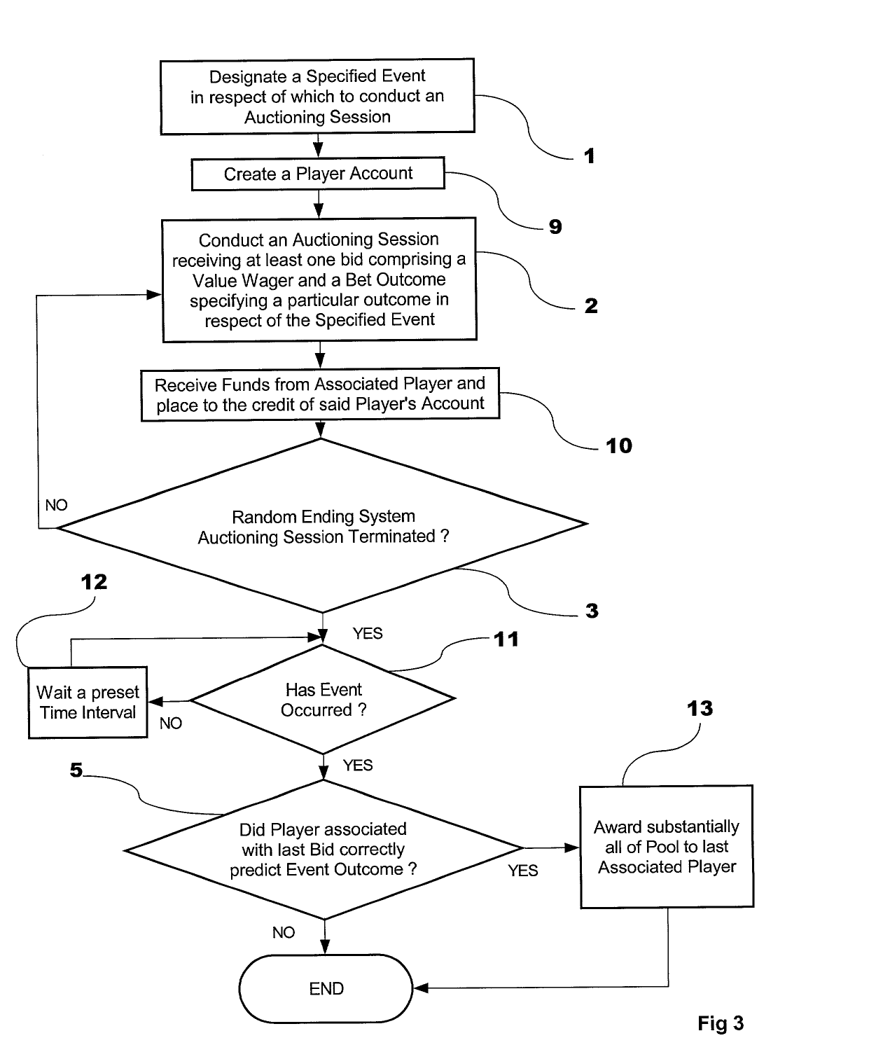

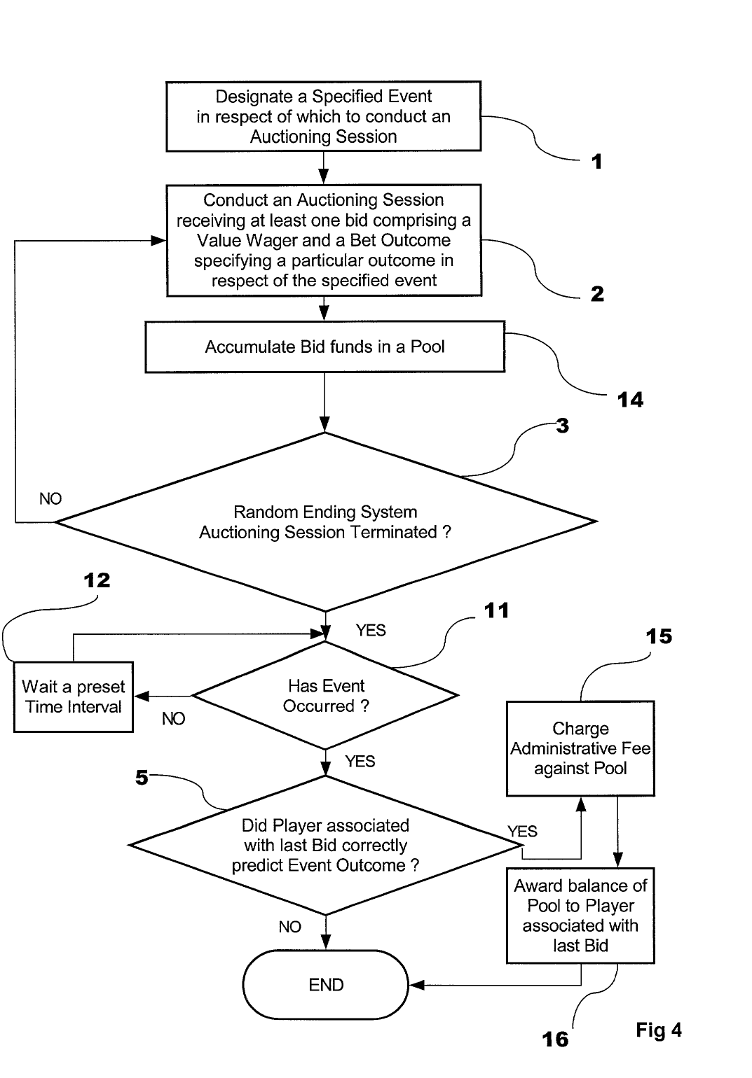

In another of its broadest embodiments shown in FIG. 3, the invention comprises a method of operating a game of chance by designating a Specified Event having a plurality of possible Outcomes 1, and thereafter 9 creating a Player Account into which the Operator conducting an Auctioning Session 2 may place the funds received 10 from the Player associated with each said Bid to the credit of said Player. Until the Auctioning Session ends randomly 3, the Operator continues to receive Bids. Subsequent to the Auctioning Session ending it is determined 11 whether or not the Specified Event has occurred. If the Event has not yet occurred, then the system waits 12 a preset time interval before again checking the Event status. Subsequent to the Event having occurred it is determined 5 whether the Player associated with the last Bid correctly predicted the Outcome of the Specified Event. The Player associated with the last Bid is awarded 13 substantially all of the Pool only if said Player correctly predicted the Outcome of the Specified Event. Similarly, in another of its broadest embodiments shown in FIG. 4, the invention comprises a method in which the Operator accumulates Bid funds in a Pool 14 subsequent to designating an Event 1, and conducting an Auctioning Session 2. After the Auctioning Session ends 3 randomly it is determined 11 whether or not the Specified Event has occurred. If the Event has not yet occurred, then the system waits 12 a preset time interval. Subsequent to the Event having occurred it is determined whether the Player associated with the last Bid correctly predicted the Outcome of the Specified Event 5. If the Player associated with the last Bid correctly predicted the Outcome of the Specified Event, then the Operator charges 15 an administrative fee against the accumulated Pool and awards the balance of the Pool 16 to the said Player. Otherwise the Operator may deal with the Pool in any number of ways that would often depend on the purpose of running the game. For example in a charity game, the entire Pool may be transferred to the cause being supported. In a commercial operation of the game a randomly varying portion (conceivably 0 percent) may be retained and the balance refunded to Players. A revenue generating feature of the present game, particularly sponsored Auctioning Sessions, comprises the display of targeted (e.g. customized to the Event or to the Player) promotional or marketing materials during the waiting period 12 between the time the Auctioning Session ends and the time that the Event ends when the Outcome becomes known for processing.

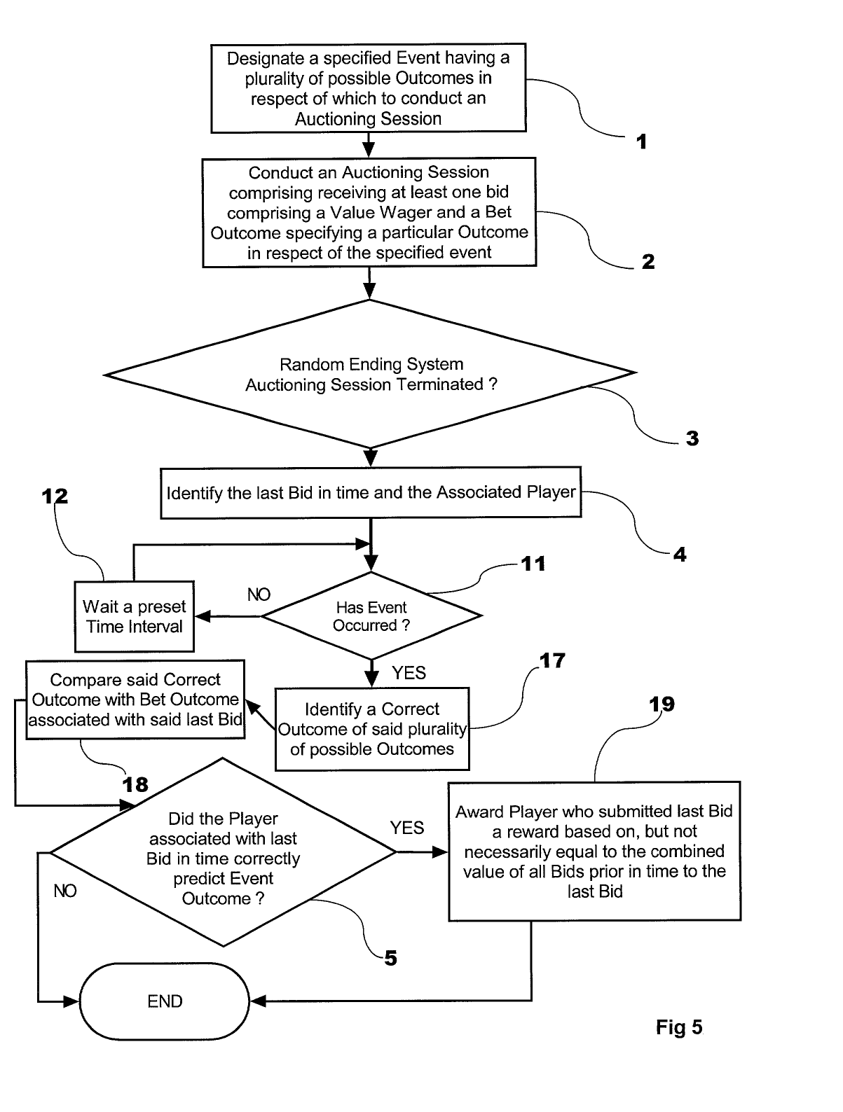

In a further alternative preferred embodiment shown in FIG. 5, the invention comprises a method of operating a game of chance by a Game Operator who designates a specified Event 1 having a plurality of possible Outcomes, and then conducts an Auctioning Session 2 by receiving Bids from a plurality of Associated Players, who Bid by placing a Value Wager along with a Bet Outcome specifying a particular outcome in respect of the Event specified by the Operator. The Operator's system ends said Auctioning Session at a randomly determined point in time 3 and identifies the last Bid in time and the Player associated therewith 4. Subsequent to the Auctioning Session ending it is determined 11 whether or not the Specified Event has occurred. If the Event has not yet occurred, then the system waits 12 a preset time interval before again checking the Event status. Once it is determined that the specified Event has occurred such that Event Outcomes are known, the gaming system identifies a Correct Outcome of said plurality of Outcomes 17. The specified Event may occur either before or after the termination of the associated Auctioning Session. In either case only after the Event has occurred, the Operator compares 18 Correct Outcomes of said Event with the Bet Outcome associated with said last Bid and if the Player associated with the last Bid in time correctly predicted the Outcome of the Specified Event 5, then the Operator awards to the Player who submitted said last Bid a reward based on, but not necessarily equal to, the pooled value of all Bids prior in time to said last Bid 19. If the Bet Outcome of the last Bid does not match said Correct Outcome, then the Operator may deal with the pooled Bids in a number of ways. In a preferred embodiment, the Operator retains the amount of the Value Wager associated with the last Bid and returns to the Associated Players the Value Wagers of all their Bids prior in time to the last Bid. In an alternate embodiment, the Operator retains the entire Pool and rewards a winning Player with non-monetary forms of compensation such as points, tickets, certificates, merchandise, credits, or vouchers of many different types. Non-winning Players may also be awarded consolation prizes that include, but are not limited to, promotional merchandise and services, “free play” type points towards future games, or other incentives.

In a further preferred embodiment, the “Auction” is a plurality of Auctioning Sessions relating to different Outcomes for each specified Event. The Game Operator determines the Events for which to offer an Auction and also which Auctioning Sessions to offer in each Auction. In other words, if the Operator offers an Auction in relation to an Event, then there will be at least one Auctioning Session offered for Players to bid to bet on the outcome of the specified Event. Moreover, Auctioning Sessions specifying the same Outcome may be offered in respect of an Event, but at different points in time or regions of the world. In the preferred embodiment, the Operator initiates each Auctioning Session by making a seed or “Lai” payment into the opening Pool—against which each Player may “bid” in an Auctioning Session with hope of recovering not only the seed, but also the value of any other wagers that are placed during an Auctioning Session. Periodically, the Operator will make a large seed payment to generate interest in a particular Auctioning Session. A person skilled in the art would know that sponsored versions of the game might have very large seed payments in exchange for marketing and advertising of products or services during the Auctioning Session.

According to the invention, in one of its broad embodiments, there is provided a novel method for operating a game of chance using a variety of communication networks that a person skilled in the art would know includes, but is not limited to: computers, telephones, PDAs, and web-enabled televisions (collectively referred to as the web-Appliances). A system of software and hardware is used to identify prospective events in respect of which the Operator may offer an Auction in relation to an Event. A web-Appliance is used by a Player to accept an Operator's offer to participate in an Auction by submitting at least one bid in an Auctioning Session that appeals to that Player. Players may submit any number of bids to any number of Auctioning Sessions from any number of locations that permit any number of types of web-Appliances access to the internet. In a preferred embodiment the processing of the submitted Bids is completed by a system at a central facility that is globally backed up by distributed, mirrored processing capacity. The system receives a wide range of data feeds that may be used to feed a central registry that keeps track in real time of bids submitted in respect of a Specified Event. In some embodiments External data provides the random input needed for the integrity of the random ending 3 functionality of Auctioning Sessions (see FIG. 2).

According to the invention, in one of its broad embodiments, the Game Operator requires that each Value Wager be of at least a minimum value. In another embodiment the Operator may impose an upper limit on each Value Wager preventing said Value Wager exceeding a maximum value, however the maximum Bid amount for an Auctioning Session may also be unlimited (i.e. infinite) and thereby effectively Player defined. In yet another embodiment of the invented game the Operator imposes both lower and upper limits on the Value Wagers accepted as Bids. To initiate bidding for any Auctioning Session, the Game Operator may place a Seed Reward of any value, said Seed Reward comprising something of value, such as a vacation trip, cruises, concert tickets, automobile, and the like, which is offered by the Game Operator as an incentive for Players to submit a Bid.

In a preferred embodiment of the disclosed invention, all Bids in each Auctioning Session relate to the same correct Outcome, and the Game Operator is able to receive a plurality of Bids effectively simultaneously for a plurality of Auctioning Sessions for a plurality of Events from a plurality of Players. In each instance the Operator will process submitted Bids into rejected and conditionally-accepted Bids by rejecting Bids that do not contain a required minimum Value Wager and conditionally accepting Bids that satisfy the minimum value. However, neither the seed reward, nor the payment associated with each bid is limited to money payments. Either a money payment or other transfer of value in the amount of the associated Value Wager may be secured from each Player to constitute an accepted Bid. The Game Operator will (normally but not necessarily) reject Bids for which money payment cannot be secured. In an alternative to a money bid the Operator will have the option of accepting non-monetary forms (e.g. concert tickets, travel or meal vouchers, professional service contracts, et cetera) of Value Wager in support of a bid. Regardless of the actual form of the Value Wager, the Operator updates a Bid database by adding an indication of each newly accepted Bid and providing notice to the Associated Player of the acceptance of the Player's Bid once accepted.

In a preferred embodiment of the disclosed invention, the financial risk to the Game Operator may be lowered by conducting at least two sessions per Auction in order to “cover” the most likely Outcomes (e.g. win or lose) and, by covering both sides, earn more money regardless of the Outcome. For popular events and longer duration “hi-stakes” Auctioning Sessions, the Operator may place and hold the Value Wagers in an interest-bearing account until at least the termination of the Auctioning Session.

In a preferred embodiment of the disclosed invention the Game Operator's systems terminate each Auctioning Session randomly using a trigger input 8 signal from an external source (see FIG. 2). A signal source triggering a random ending could be, for example, when the Dow Jones industrial average reaches a certain identified value. Other random ending events could be the arbitrary selection of an event that triggers a timed count-down such as the selection of the day on which the Stanley Cup playoffs will end in the year 2002, which external event will occur, but exactly when is not known. Similarly randomly triggered count-downs may be used to generate a plurality of randomly selected intervals such that the random ending of Auctioning Sessions may occur within any interval that is randomly selected to be before, during, or subsequent to occurrence of the specified Event—such that randomness is two-fold with the random expiry of the time count-down taking place during a randomly selected interval. At the same time, according to the invention, in one of its broad embodiments, a plurality of random ending criteria exist. A person skilled in the art would know that the trigger may be temporal, financial, based on the number of bids submitted, or driven by any completely external resource unrelated to the specified Event—or any combination of the foregoing capable of constituting a random trigger for ending the Auctioning Session. A random interval of time may be determined by specifying a parameter that varies uncontrollably over time (e.g. the number of Bids received, the score in the specified Event, the score in an Event other than the specified Event, the cumulative value of the Value Wagers received, or the value of specified shares as listed on a specified financial exchange) and when that parameter is achieved, triggering initiation or termination.

In a further preferred embodiment of the invention, only the final accepted Bid achieves the objective of securing the right of the chance to take all the money in the Pool. In such preferred embodiment, the random ending 3 of each auctioning session tends to reduce the opportunity for well-financed Players to have an advantage in capturing a given Pool. However, unlike a traditional Auction, each accepted Bid does remain at risk until the Event outcome is known 11 and the Auctioning Session has ended (see FIG. 4). Consequently, once a particular Player has been outbid, the incentive to bid again, increases, since the funds of the initial and all subsequent bids of that Player remain at risk of loss until the Event outcome is known 11—unless that Player has an additional bid accepted to secure that Player's chance at winning the Pool. At the same time, each accepted bid puts new value at risk, such that that Player's potential losses continue to accumulate.

In a further of its broad embodiments, the invention discloses a method of operating a game in which in order to qualify, a bid must be: larger than the previous bid, a specified increment (if any for that session) larger than the previous bid, no larger than a specified ceiling increment (if any for that session), conditionally accepted before the auctioning session to which it applies ends at random, and fully paid in advance as a condition of acceptance. Consequently, for high-paced, large stakes games, Players will prefer a pre-funded account approach that permits rapid bid acceptance confirmation—rather than either the slower credit card approval or direct external transfer means of securing bid funds. Moreover, the Game Operator may specify or permit Players to select specifications respecting Event Outcomes that are general (i.e. to Win, Lose, or Draw) or particular (i.e. Win by 3 points, Score 21-16). Point spreads and odds are part of an alternate embodiment of the game Operation method through which Operators may keep the game offerings fresh and Player interest high.

The game of the present invention includes two separate risks. First, the risk that the Player will be one of those who does not “win the auction” yet will have the substantial cumulative value of all the Player's bids remain in the pool with no hope of winning the pool. Second, the risk to the one Player who does “win the auction” that the outcome of the event will not be as the Player specified, such that having “won the auction” the Player now “loses the game”. As with most money “games of chance” the desired outcome is to win a pool of funds or a “pot” of substantially greater value than the amounts placed at risk during the game, however in the present invention, entry into the real “game” is only achieved through winning an Auctioning Session that ends at random, the unpredictability of which random ending tends to create additional excitement for Players. There will also be some appeal to the global potential of having “high rollers” active in any auctioning session, which activity will enhance the size of the pool available to the winning Player. At the same time, the randomness of the ending combined with restrictions on the maximum bid will create an environment that tends to “level the field” giving less wealthy Players hope of winning despite the presence of high rollers in an auctioning session.

There are a number of ways in which a random ending of auctioning sessions may be accomplished, the most common being a temporal mechanism that could be based on, for example, the time of decay of a radioactive source. However, the main objective of deploying a random ending is to reassure the public that the game is NOT “fixed”, such that the present invention contemplates using a variety of data feeds that the general public will understand are outside the Operator's control. Some feeds will be internal such as the financial data records (e.g. pool size or bid size) that are supplied by Players. Other feeds will be purely external such as the score or occurrence of a point spread in an separate sporting event elsewhere in the world. The temperature, weather conditions, number of cars on a road, and other data available online, all represent random sources of data to end the game.

Another feature of the game that tends to create excitement is the possibility that the random ending of the auctioning session will occur after the conclusion of the event in respect of which the auctioning session is offered. Clearly, once the outcome of the event is known, the “second risk” will be eliminated from auctioning sessions with that outcome specified, in which circumstances the Player who “wins the auction” also wins the pool. With a guaranteed win at stake—the frequency and level of the bidding is likely to increase in a post-Event session of rapid action with each Player submitting Bids repeatedly and quickly in an effort to enter the last Bid before the session terminates.

An important feature of a preferred embodiment of the game is that, even with Players normally multiple bidding, for the Player who “wins the auction” said Player is truly only risking the amount of said Player's last bid. If said Player bet incorrectly (i.e. event outcome not equal to specification), then said Player gets ALL the said Player's prior Value Wager amounts refunded and said Player forfeits to the Operator only the amount the Value Wager of said Player's last bid. If the Player bet correctly (i.e. outcome equals specification), then the Player takes the entire pool, which includes ALL the Player's prior bids. The result is that, once Players submit their first bid they each have a substantial incentive to “stay on top” and become the holder of the last bid. The penalty for failure to win an auctioning session is that Players need to “turn on their team” and hope their own team loses the event in order to recover the Player's own money because the cumulative value of all their bids is lost if they have correctly specified the outcome but failed to be the “last man standing” in the auction. There will be a highly aggressive group of Players who will have trouble understanding that they cannot control the outcome of the auctioning sessions by “brute force” alone—due to the externally controlled random ending feature. The Operator will have the opportunity to deploy a variety of different interface elements, including count-down clocks and hour glasses to create suspense and a feeling of time pressure in addition to using targeted visual and audio taunts to apply “peer pressure” to keep reluctant earlier bidders in the auction on the expectation that their next bid might get them in before the ending.

In the preferred embodiment of the disclosed invention the Game Operator will engage many optional features to maximize Player excitement and repeat participation in the online gaming experience. In recognition of the fact that in addition to large rewards for success in both the Auction and the Game, fear and uncertainty tend to create a state of suspense in human Players, who find the stimulation therefrom appealing. Fear in Players is based on things that the Players do not know and cannot control, such as: their adversaries' character and financial capacity (Will they outbid me? Can they outbid me?), the time remaining to play before the random ending of the auction session prevents a Player from recovering active status as the holder of the last accepted bid. Visual and audio stimuli that flatter and persuade or taunt and pressure into action by shame, as well as the cumulative value at risk—also act to attract bids.

The preferred embodiment of the disclosed invention includes elements designed to generate and sustain Player participation enhancing Game suspense and Player excitement by: ending Auctioning Sessions at random, building Player confidence by ensuring and promoting random means of ending, facilitating Player interaction by instantaneously notifying each Player who submitted a prior Bid once a different Player holds a more recent Bid in time, and enhancing Goodwill by continuously and in real-time announcing Auctioning Session financial outcomes, payouts and other gaming statistics. Player excitement is created and enhanced by: engaging warnings and taunts to create fear, anger, indignation, suspense, and uncertainty by delivering graphic user interface (“GUI”) elements including count-down clocks and other forms of visual and audio stimuli, dynamically altering and announcing changes to session parameters, as well as dynamically replacing Auctioning Sessions, according to an interest level assessment whenever sessions end prematurely. The disclosed method of game operation also contemplates engaging the “team loyalty” instincts of some Players by imposing a penalty for failure to win the Auctioning Session comprising the threat of another Player taking the Value Wager of a non-final Player when said non-final Player has in fact specified a correct Outcome. Players are also motivated to remain active in Auctioning Sessions for a chance to win the Pool upon winning the Auctioning Session, because the method of game operation exploits Player confusion with the classic auction in which only the bid made last in time remains at risk.

The preferred embodiment of the disclosed invention includes operational elements designed to enhance Player confidence by: allowing and promoting the perception of Players that one can always win the Auctioning Session by simply bidding higher, receiving trusted data feeds respecting an Outcome of the Event associated with each Auctioning Session, providing Player support live by telephone and chat-line, and storing Player accepted bid results in case of interruption due to any system failure risking no-fault loss.

The preferred embodiment of the disclosed invention includes operational elements designed to enhance Player access by: deploying dedicated access terminals conveniently and strategically placed in hotel rooms and sports bars, permitting alternate forms of reward (e.g. points, chattels and other items and services of value) to facilitate barter style exchanges as reward payment means, and delivering targeted content (based on time zone, currency, and language processing) to enhance the opportunity for the Operator to receive parallel revenue streams from marketing.

The preferred embodiment of the disclosed invention includes operational elements designed to motivate Players to enter an Auctioning Session by: promoting and exploiting the Player perception that the Game risk is low (since if Players do not specify a correct Outcome, then all their prior bids will be refunded), as well as promoting and exploiting the Player perception that the Game “money odds” are good due to a potentially very high return on any Outcome—specifically that the odds are better than the classic Pari-mutuel betting model, in which the return to Players betting on favourites is low—thereby attracting Players from the traditional casino game market to play games based on the disclosed invention.

Although the disclosure describes and illustrates preferred embodiments of the invention, it is to be understood that the invention is not limited to these particular embodiments. Many variations and modifications will now occur to those skilled in the art of gambling. For full definition of the scope of the invention, reference is to be made to the appended claims.

We claim:

1. A method of operating a game of chance by a Game Operator, comprising the steps of:
designating a specified Event having a plurality of possible Outcomes;
offering an Auctioning Session, said Auctioning Session comprising receiving at least one Bid from an Associated Player wherein said Bid comprises a Value Wager and a Bet Outcome specifying a particular Outcome in respect of the specified Event;
ending said Auctioning Session at a randomly determined point in time;
identifying the last Bid in time and the Associated Player;
subsequent to occurrence of said Event, identifying a Correct Outcome of said plurality of Outcomes;
comparing said Correct Outcome of said Event with the Bet Outcome associated with said last Bid; and
if the Bet Outcome associated with said last Bid matches said Correct Outcome, awarding to the Player who submitted said last Bid a reward based on, but not necessarily equal to, the combined value of all Bids prior in time to said last Bid.

2. The method as claimed in claim 1, wherein if the Bet Outcome of said Last Bid does not match said Correct Outcome, then awarding the Value Wager associated with said last Bid to said Game Operator.

3. The method as claimed in claim 1 further comprising the step of offering a Seed Reward for each Auctioning Session, said Seed Reward comprising something of value offered by the Game Operator as an incentive for Players to submit a Bid.

4. The method as claimed in claim 1 further comprising the step of requiring each Value Wager to be of at least a minimum value.

5. The method as claimed in claim 2 further comprising the step of returning to the Associated Players the Value Wager of all their Bids prior in time to the last Bid when the last Bid does not match said correct Outcome.

6. The method as claimed in claim 1 further comprising receiving a plurality of Bids simultaneously for a plurality of Auctioning Sessions for a plurality of Events from a plurality of Players.

7. The method as claimed in claim 1 further comprising the step of having all Bids in each Auctioning Session relate to the same correct Outcome.

8. The method as claimed in claim 1 further comprising the step of generating a plurality of randomly selected intervals during which said random ending of said Auctioning Session occurs before, during, or subsequent to occurrence of said Event.

9. The method as claimed in claim 8 further comprising the step of ending said Auctioning Session after a randomly selected interval of time which interval expires subsequent to occurrence of said Event.

10. The method as claimed in claim 4 further comprising the step of processing submitted Bids into rejected and conditionally-accepted Bids, said processing comprising rejecting Bids that do not contain a required minimum Value Wager, and conditionally accepting Bids that satisfy said minimum value; thereafter securing payment in the amount of said Value Wager from each Associated Player to form accepted Bids, and rejecting Bids for which payment cannot be secured; updating a Bid database containing an indication of all Bids received by adding an indication of the accepted Bids; and providing notice to the Associated Players of the acceptance of their Bid if accepted.

11. A method of operating a game of chance comprising the steps of:
designating a specified Event having a plurality of possible Outcomes;
creating with respect to an Associated Player a Player Account that is provided with funds by said Associated Player;
offering an Auctioning Session said Auctioning Session comprising receiving Bids from a plurality of Associated Players, wherein each Bid comprises a Value Wager and a Bet Outcome specifying a particular outcome in respect of the Specified Event;
accumulating the Value Wagers of all Bids into a Pool;
terminating the Auctioning Session after a random interval of time;
upon occurrence of an Outcome of said plurality of Outcomes in respect of said Event, determining the last Associated Player prior to termination of said Auctioning Session, and determining if the Bid of said Associated Player predicted said Outcome of said plurality of Outcomes; and
providing substantially all of the Pool to said last Associated Player if said last Associated Player predicted said Outcome of said plurality of Outcomes.

12. The method as claimed in claim 11 further comprising the step of the charging an administrative fee against the Pool.

13. The method as claimed in claim 11 further comprising the step of placing the Value Wagers of each Bid in an interest-bearing account and holding same in said interest-bearing account until at least the termination of the Auctioning Session.

14. A method of operating a game of chance comprising the steps of:
designating a specified Event having a plurality of possible Outcomes;
conducting an Auctioning Session, said Auctioning Session comprising receiving Bids from a plurality of Associated Players, wherein each Bid comprises a Value Wager and a Bet Outcome specifying a particular outcome in respect of the specified Event; and
terminating said Auctioning Session after a random interval of time.

15. The method as claimed in claim 14 further comprising the step of identifying the Player associated with the last Bid.

16. The method as claimed in claim 15 further comprising the step of awarding at least one Player an award if said Player's Bet Outcome matches the Outcome of said specified Event.

17. The method as claimed in claim 16 wherein said at least one Player is the Player who last submitted a Bid immediately prior to termination of said Auctioning Session.

18. The method as claimed in claim 17, said random interval of time determined by specifying a parameter that varies over time and at a time when said parameter is achieved, terminating said Auctioning Session.

19. The method as claimed in claim 18, wherein said parameter is selected from the group of parameters consisting of:
the number of Bids received;
the score in the specified Event;
the score in an Event other than the specified Event;
the cumulative value of the Value Wagers received; and
the value of the shares as listed on a specified financial exchange reaching a pre-selected amount.

20. The method as claimed in claim 1 further comprising the step of imposing a limit on each Value Wager preventing said Value Wager exceeding a maximum value.
